(19) United States
(12) Patent Application Publication
(10) Pub. No.: US 2023/0166914 A1
(43) Pub. Date: Jun. 1, 2023

(54) AUTOMATED WAREHOUSE SYSTEM AND AUTOMATED WAREHOUSE CONTROL METHOD

(71) Applicant: DAIFUKU CO., LTD., Osaka (JP)

(72) Inventors: Tomohiko KAWASHIMA, Shiga (JP); Ryo NAKAGAWA, Shiga (JP)

(73) Assignee: DAIFUKU CO., LTD., Osaka (JP)

(21) Appl. No.: 17/963,547

(22) Filed: Oct. 11, 2022

(30) Foreign Application Priority Data
Nov. 30, 2021 (JP) 2021-194315

(51) Int. Cl. B65G 1/137; B65G 1/04; G06K 7/14

(52) U.S. Cl. CPC B65G 1/1375; B65G 1/1371; B65G 1/0421; G06K 7/1417; B65G 2203/0216; B65G 2203/0283; B65G 2203/041

(57) ABSTRACT

Easy learning of the position of a placement part of an automated warehouse is made possible. An automated warehouse system includes a plurality of placement parts in which to place an object to be transported and which are fixed to an automated warehouse, each placement part having marked thereon an identification code representing identification information for identifying that placement part. A crane is equipped with an image taking section configured to take an image. A control device is configured to: detect, from an image taken by the image taking section and including the identification code of the placement part, the identification information represented by the identification code; and store the identification information having been detected and crane position information concerning a position where the crane is located when the image is taken, with the identification information having been detected and the crane position information being associated with each other.

This Nonprovisional application claims priority under 35 U.S.C. § 119 on Patent Application No. 2021-194315 filed in Japan on Nov. 30, 2021, the entire contents of which are hereby incorporated by reference.

### TECHNICAL FIELD

The present invention relates to an automated warehouse system and an automated warehouse control method.

### BACKGROUND ART

In an automated warehouse system, a transferring section of an article transport device is moved in a horizontal direction and in an up-and-down direction in moving space so as to be located at a target stop position of a storage part. In the automated warehouse system, an article is then put in or taken out at the target stop position by using the transferring section. This enables storage of the article in the storage part of an article storage rack and retrieval of the article from the storage part of the article storage rack.

Patent Literature 1 is directed to an automated warehouse system. In the automated warehouse system, a transferring means is moved such that a learning marker detection means can detect both ends of a learning marker in one of a horizontal movement direction and an up-and-down movement direction of the transferring means. In the automated warehouse system, one of learned horizontal distance information and learned up-and-down distance information is then learned in accordance with detection information detected by a horizontal movement distance detection means or an up-and-down movement distance detection means when the learning marker detection means detects at least one of the ends of the learning marker. In the automated warehouse system, the other one of the learned horizontal distance information and the learned up-and-down distance information is also learned in accordance with detection information detected by the horizontal movement distance detection means or the up-and-down movement distance detection means when the learning marker detection means detects both of the ends of the learning marker.

### CITATION LIST

### Patent Literature

[Patent Literature 1]

Japanese Patent Application Publication, Tokukai, No. 2008-044732

### SUMMARY OF INVENTION

### Technical Problem

According to Patent Literature 1 above, in the automated warehouse system, the learned horizontal distance information and the learned up-and-down distance information are detected and learned by shedding light on a light reflector (learning marker) on which a trapezoidal sticker is affixed and detecting reflected light by using a laser sensor.

In the above automated warehouse system, the position of a shelf, etc. of an automated warehouse is learned by detecting the reflected light from the learning marker. For example, since the detection range is narrow, affixation of the learning marker is strictly limited in terms of a position of the affixation relative to a position where the article is put in and taken out. It is therefore necessary for a worker to manually adjust the position of the learning marker, and affix the learning marker while communicating with another worker who operates a controller. Affixing a learning marker to a shelf, etc. of an automated warehouse is manual work at a high place. This makes it impossible to ensure the safety of the worker, and increases the workload of the worker.

An object of an aspect of the present invention is to provide an automated warehouse system and an automated warehouse control method that enable easy learning of the position of a placement part of an automated warehouse.

### Solution to Problem

In order for the above problem to be solved, an automated warehouse system in accordance with an aspect of the present invention includes: an automated warehouse in which an object to be transported is transferred by using a crane; and a control device for controlling the crane, the automated warehouse system including a plurality of placement parts in which to place the object to be transported and which are fixed to the automated warehouse, each of the plurality of placement parts having marked thereon an identification code representing identification information for identifying that placement part, the crane including a carriage equipped with an image taking section for taking an image, the control device being configured to: detect the identification information represented by the identification code from an image that is taken by the image taking section and that contains the identification code of a placement part of the plurality of placement parts; and store the identification information having been detected and crane position information concerning a position where the crane is located when the image is taken, with the identification information having been detected and the crane position information being associated with each other.

In order for the above problem to be solved, an automated warehouse control method in accordance with an aspect of the present invention is a method for controlling an automated warehouse in which an object to be transported is transferred by using a crane, the automated warehouse including a plurality of placement parts in which to place the object to be transported and which are fixed to the automated warehouse, each of the plurality of placement parts having marked thereon an identification code representing identification information for identifying that placement part, the crane including a carriage equipped with an image taking section for taking an image, the method including: detecting the identification information represented by the identification code from an image that is taken by the image taking section and that contains the identification code of a placement part of the plurality of placement parts; and storing the identification information having been detected and crane position information concerning a position where the crane is located when the image is taken, with the identification information having been detected and the crane position information being associated with each other.

### Advantageous Effects of Invention

An aspect of the present invention enables easy learning of the position of a placement part of an automated warehouse.

### BRIEF DESCRIPTION OF DRAWINGS

FIG. 1 is a perspective view of an automated warehouse system in accordance with an embodiment of the present invention.

FIG. 2 is a side view of a stacker crane.

FIG. 3 is a block diagram of an example of the configuration of a control section of the automated warehouse system in accordance with an embodiment of the present invention.

FIG. 4 is an explanatory diagram of a method for learning identification code position information, the method being carried out by a control device in accordance with an embodiment of the present invention.

FIG. 5 is a diagram illustrating an example of an image containing an identification code affixed to a shelf.

FIG. 6 is a diagram illustrating an example of an image containing an identification code affixed to a device port.

FIG. 7 is an explanatory flowchart of the procedure of a process to be performed in learning a placement part of the automated warehouse system in accordance with an embodiment of the present invention.

FIG. 8 is an explanatory flowchart of the procedure of a process performed when the automated warehouse system in accordance with an embodiment of the present invention is in operation.

FIG. 9 is an explanatory diagram of a transfer OK range that is set within the shooting range of an image taking section.

### DESCRIPTION OF EMBODIMENTS

Overall Configuration of Automated Warehouse System 100

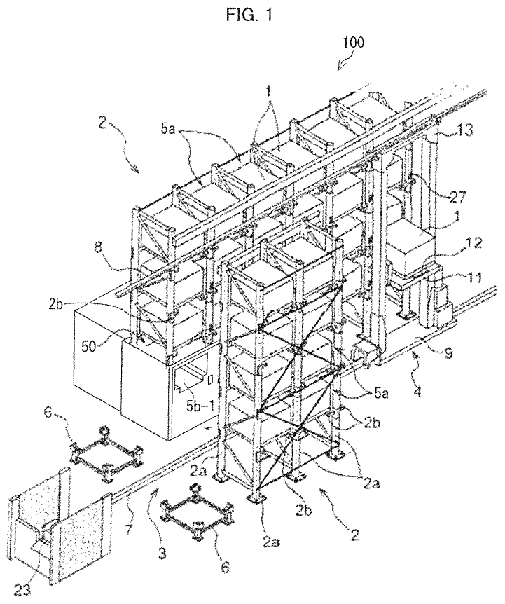

The following description will discuss the configuration of an automated warehouse system in accordance with an embodiment of the present invention, with reference to the drawings. FIG. 1 is a perspective view of an automated warehouse system 100 in accordance with an embodiment of the present invention. The automated warehouse system 100 includes: two article storage racks 2 installed so as to have a space therebetween such that the front sides thereof through which an object to be transported 1 is put in and taken out face each other; and a stacker crane 4 serving as an article transport device configured to automatically shuttle in moving space 3 formed between the two article storage racks 2. The object to be transported 1 may be transported while being held in a cassette, or may be transported by itself.

Each of the article storage racks 2 includes a plurality of front-and-rear pairs of pillars 2a. The plurality of front-and-rear pairs are set upright so as to be spaced in a rack breadth direction (in a horizontal direction). Each of the pillars 2a in the front-and-rear pair includes a plurality of placement supporters 2b that are spaced in an up-and-down direction.

A placement part 5 is designed to store the object to be transported 1 in such a manner that the object to be transported 1 is placed on and thereby supported by the placement supporters 2b in a left-and-right pair. A plurality of placement parts 5 are arranged in a rack up-and-down width direction (up-and-down direction) and in the rack breadth direction. The placement part 5 may be a shelf 5a, or may be a device port 5b (described later). The shelf 5a and the device port 5b are collectively referred to as the placement part 5.

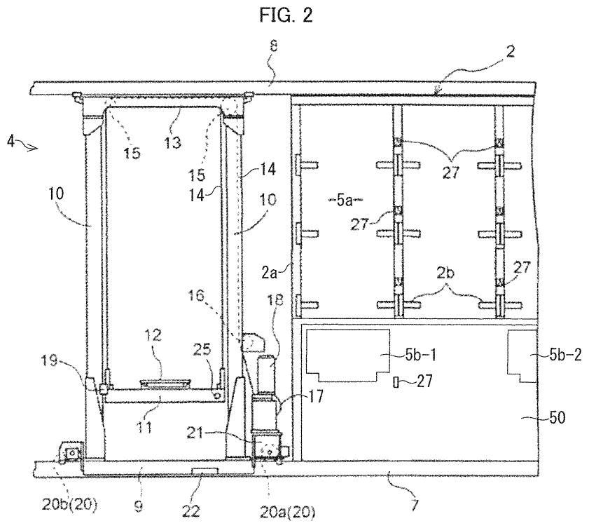

As illustrated in FIGS. 1 and 2, the device port 5b includes a receipt part 5b-1 or an issue part 5b-2 of a processing device 50 that performs a process on the object to be transported 1. The device port 5b may include both the receipt part 5b-1 and the issue part 5b-2. The receipt part 5b-1 and the issue part 5b-2 are collectively referred to as the device port 5b.

Receiving and issuing load-placement stands 6 are installed in locations adjacent to the article storage racks 2 in the rack breadth direction. An object to be transported 1 to be stored in the article storage rack 2 and an object to be transported 1 to be retrieved from the article storage rack 2 are placed on and supported by the load-placement stands 6.

In the moving space 3, a travel rail 7 is installed on the floor so as to extend in the rack breadth direction across the entire range of the article storage racks 2 and the receiving and issuing load-placement stand 6, and a guide rail 8 is installed in an elevated position near the ceiling so as to extend in the rack breadth direction across the entire range of the article storage racks 2 and the receiving and issuing load-placement stand 6. In addition, a stacker crane 4 is provided so as to move horizontally on the travel rail 7 while being guided by the guide rail 8.

The automated warehouse system 100 also includes the device port 5b for receiving and delivering the object to be transported 1 when the object to be transported 1 is transported to the processing device configured to perform a process on the object to be transported 1 and when the object to be transported 1 is collected from the processing device. The device port 5b includes: a receipt part for transporting the object to be transported 1 to the processing device; and an issue part for collecting the object to be transported 1 from the processing device.

As illustrated in FIG. 2, the stacker crane 4 includes: a travel dolly 9 capable of freely traveling along the travel rail 7; a carriage 11 capable of freely moving up and down along a raising and lowering mast 10 set upright on the travel dolly 9; and an article transfer device (e.g., a fork) 12 mounted on the carriage 11. The stacker crane 4 is thus configured, so that a travel action of the travel dolly 9 enables the article transfer device 12 to freely move horizontally and an up-and-down movement action of the carriage 11 enables the article transfer device 12 to freely move up and down.

The stacker crane 4 is configured to transfer the object to be transported 1 to and from the receiving and issuing load-placement stand 6 and put the object to be transported 1 in and take the object to be transported 1 out of the placement part 5, through the travel action of the travel dolly 9, the up-and-down movement action of the carriage 11, and the transfer action of the article transfer device 12.

The stacker crane 4 includes a front-and-rear pair of raising and lowering masts 10, that is, one raising and lowering mast 10 is provided in each of a front end part and a back end part of the travel dolly. Provided in the upper part of the raising and lowering mast 10 is an upper frame 13 for connecting together the upper parts of the front-and-rear pair of raising and lowering masts 10. This upper frame 13 is provided so as to be guided by the guide rail 8.

The carriage 11 is guided and supported, by the front-and-rear pair of raising and lowering masts 10 set upright on the travel dolly 9, so as to freely move up and down. The carriage 11 is suspended and supported by a raising and lowering wire 14 connected to both the left and right sides of the carriage 11.

The raising and lowering wire 14 is pulled over guide pulleys 15 provided in the upper frame 13 and a guide pulley 16 provided in one of the raising and lowering masts 10, and wound around a wind-up drum 17 provided at one edge of the travel dolly 9.

The wind-up drum 17 is provided with an inverter-type, raising and lowering electric motor 18. The raising and lowering electric motor 18 rotates in forward and reverse directions to provide power. This enables the raising and lowering wire 14 to be fed and wound so that the carriage 11 moves up and down and the article transfer device 12 thereby moves up and down.

The carriage 11 is provided with a raising and lowering encoder 19 for detecting an up-and-down movement distance from a reference up-and-down position to the article transfer device 12 in an up-and-down movement direction of the article transfer device 12. Note that the raising and lowering encoder 19 may be a linear encoder, or may be a rotary encoder.

The reference up-and-down position is set at the position of the article transfer device 12 located when the carriage 11 is located on the travel dolly 9. This reference up-and-down position (not illustrated) is detected in a manner such that a detector such as a limit switch provided to the carriage 11 detects a dog to be detected that is provided to the travel dolly 9. A rotation shaft of the raising and lowering encoder 19 is provided with a sprocket that fits into a chain provided along a longitudinal direction of the raising and lowering mast 10. The up-and-down movement distance from the reference up-and-down position to the article transfer device 12 is therefore detected by detecting an up-and-down movement distance that the carriage 11 moves after the detection of the reference up-and-down position.

In the stacker crane 4, the travel dolly 9 is provided with a front-and-rear pair of travel wheels 20 disposed such that the travel wheels have a space therebetween in a longitudinal direction of the travel rail 7. A travel wheel 20a that is one of the front-and-rear pair of travel wheels 20 serves as a driving wheel, whereas a travel wheel 20b that is the other one serves as a driven wheel capable of freely rotating. The travel wheel 20a is provided with an inverter-type, traveling electric motor 21. The traveling electric motor 21 rotates in forward and reverse directions to provide power. This causes the travel dolly 9 to travel along the travel rail 7 and thereby causes the article transfer device 12 to move horizontally.

The travel dolly 9 is provided with a traveling encoder 22 for detecting a horizontal movement distance from a reference horizontal position to the article transfer device 12 in a horizontal movement direction of the article transfer device 12. Note that the traveling encoder 22 may be a linear encoder, or may be a rotary encoder.

The reference horizontal position is set at one of the edges of the travel rail 7 that is closer to the receiving and issuing load-placement stands 6. This reference horizontal position (not illustrated) is detected in a manner such that a detector such as a limit switch provided to the travel dolly 9 detects a dog to be detected that is provided on the ground. A rotation shaft of the traveling encoder 22 is provided with a sprocket that fits into a chain provided along a longitudinal direction of the travel rail 7. The horizontal movement distance from the reference horizontal position to the article transfer device 12 is therefore detected by detecting the horizontal movement distance that the travel dolly 9 moves after the detection of the reference horizontal position.

Configuration Example of Control Device 23

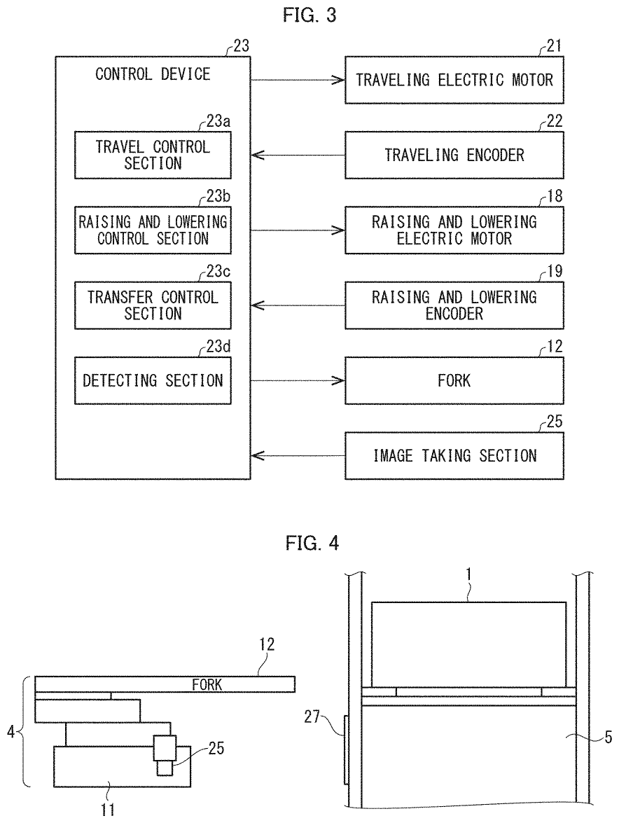

As illustrated in FIG. 3, the automated warehouse system 100 includes a control device 23 that controls the operation of the stacker crane 4. The control device 23 controls the travel action of the travel dolly 9 and the up-and-down movement action of the carriage 11 such that: a receiving and issuing load-placement stand 6 to be used for transfer is selected from the two receiving and issuing load-placement stands 6, or a placement part 5 to be used for transfer is selected from the plurality of placement parts 5; and the article transfer device 12 is moved to a target stop position corresponding to the receiving and issuing load-placement stand 6 to be used for the transfer, or to a target stop position corresponding to the placement part 5 to be used for the transfer.

The control device 23 also controls a transfer action of the article transfer device 12 such that, at the target stop position, the article transfer device 12 transfers the object to be transported 1 to and from the receiving and issuing load-placement stand 6 or puts the object to be transported 1 in and takes the object to be transported 1 out of the placement part 5 to be used for the transfer.

The control device 23 may include two controllers that are a ground-side controller provided on the ground and a crane-side controller provided to the stacker crane in a manner that allows the control device 23 to freely communicate with the ground-side controller and the crane-side controller. Alternatively, the control device 23 may include a single controller that is a ground-side controller provided on the ground in a manner that allows the control device 23 to freely communicate with the ground-side controller and the raising and lowering electric motor 18, the traveling electric motor 21, and another equipment provided in the stacker crane.

The target stop position for the placement part 5 is a position used for properly putting the object to be transported 1 in and taking the object to be transported 1 out of the placement part 5, and is set for each of the plurality of placement parts 5. Further, the target stop position is determined with use of information on a target horizontal distance from the reference horizontal position in the horizontal movement direction of the article transfer device 12 and information on a target up-and-down distance from the reference up-and-down position in the up-and-down movement direction of the article transfer device 12.

In the present embodiment, the target stop position is set at a middle position between a target stop position for unloading the object to be transported 1 and putting the same in the placement part 5 and a target stop position for scooping the object to be transported 1 and loading the same on the article transfer device 12. The following description will discuss the article transfer device 12 by taking a fork as an example.

The target stop position for unloading is determined so as to make it possible to avoid collision of the object to be transported 1 with the pillars 2a and with the placement supporters 2b when the fork 12 is moved in and out with the object to be transported 1 being placed on and supported by the fork 12.

Like the target stop position for the placement part 5, a target stop position for the receiving and issuing load-placement stand 6 is also a position used for properly transferring the object to be transported 1 to and from the load-placement stand 6. The target stop position for the receiving and issuing load-placement stand 6 is determined with use of information on a target horizontal distance from the reference horizontal position in a horizontal movement direction of the fork 12 and information on a target up-and-down distance from the reference up-and-down position in an up-and-down movement direction of the fork 12. Note that a target stop position of the stacker crane 4 in the up-and-down movement direction and a target stop position of the stacker crane 4 in the horizontal movement direction are referred to as crane position information.

FIG. 3 is a block diagram of an example of the configuration of the control section of the automated warehouse system 100 in accordance with an embodiment of the present invention. The control device 23 includes: a travel control section 23a; a raising and lowering control section 23b; a transfer control section 23c; and a detecting section 23d.

The travel control section 23a controls actions of the traveling electric motor 21 in accordance with detection information of the traveling encoder 22 and the information on the target horizontal distance, so that the fork 12 horizontally moves to the target stop position in the horizontal movement direction of the article transfer device 12.

The raising and lowering control section 23b controls actions of the raising and lowering electric motor 18 in accordance with the detection information of the raising and lowering encoder 19 and the information on the target up-and-down distance, so that the article transfer device 12 moves up and down to the target stop position in the up-and-down movement direction of the fork 12.

The transfer control section 23c controls the transfer action of the fork 12, so that the object to be transported 1 is transferred to and from the load-placement stand 6 or the object to be transported 1 is put in and taken out of the placement part 5.

The travel control section 23a makes the traveling electric motor 21 start operating to start the travel action of the travel dolly 9. When a horizontal movement distance detected by the traveling encoder 22 reaches the information on the target horizontal movement distance for the load-placement stand 6 or the placement part 5 to be used for the transfer, the travel control section 23a stops the traveling electric motor 21 from operating so that the fork 12 is located at the target stop position in the horizontal movement direction of the fork 12.

The raising and lowering control section 23b makes the raising and lowering electric motor 18 start operating to start the up-and-down movement action of the carriage 11, in order to unload the object to be transported 1 and put the same in the placement part 5 or on the load-placement stand 6. When an up-and-down movement distance detected by the raising and lowering encoder 19 reaches the information on the target up-and-down distance for the load-placement stand 6 or the placement part 5 to be used for the transfer, the raising and lowering control section 23b stops the raising and lowering electric motor 18 from operating. The raising and lowering control section 23b then causes the fork 12 to be located at a target stop position for unloading that is upper than the target stop position by a preset distance.

When the object to be transported 1 is scooped and removed from the placement part 5 or the load-placement stand 6, the raising and lowering control section 23b performs an action similar to that performed when the object to be transported 1 is unloaded and put in the placement part 5 or on the load-placement stand 6, so that the fork 12 is located at a target stop position for scooping that is lower than the target stop position by a preset distance.

In a case of unloading the object to be transported 1 and putting the same in the placement part 5 or on the load-placement stand 6, the transfer control section 23c causes the fork 12 to protrude with the object to be transported 1 being placed on and supported by the fork 12, then lowers the carriage 11 and thereby lowers the article transfer device 12 to the target stop position for scooping to unload the object to be transported 1 and put the same in the placement part 5 or on the load-placement stand 6, and then retracts the fork 12. In a case of scooping the object to be transported 1 and removing the same from the placement part 5 or the load-placement stand 6, the transfer control section 23c causes the fork 12 to protrude, then raises the carriage 11 and thereby raises the fork 12 to the target stop position to scoop and remove the object to be transported 1, and then retracts the fork 12 with the object to be transported 1 being placed on and supported by the fork 12.

In order to move the fork 12 to each target stop position for a corresponding one of the plurality of placement parts 5, the control device 23 needs to obtain information on the target horizontal distance and information on the target up-and-down distance for each of the plurality of target stop positions.

Learning of Identification Code Position Information

FIG. 4 is an explanatory diagram of a method for learning identification code position information, the method being carried out by a control device 23 in accordance with an embodiment of the present invention. A plate member 27 on which an identification code is marked is affixed so as to correspond to each of the placement parts 5 (see FIGS. 1 and 2). The plate member 27 may be replaced with a sticker on which an identification code is marked.

The identification code marked on the plate member 27 affixed so as to correspond to each of the placement parts 5 has represented therein identification information that is a unique, arbitrary value. To the carriage 11 of the stacker crane 4, an image taking section 25 is fixed. The position where the image taking section 25 is attached is adjusted with use of the identification code affixed to a reference rack.

The position of an identification code is adjusted such that, when the stacker crane 4 moves to a position corresponding to the crane position information, the identification code is contained in an image taken by the image taking section 25. When the identification code is contained in an image taken by the image taking section 25, it is possible for the detecting section 23d of the control device 23 to detect the identification code. This eliminates the need to manually adjust the position of the identification code. It is therefore possible to ensure the safety of a worker and successfully shorten the working hours of the worker. Note that the size of the identification code relative to the size of the image is not limited to any particular size, provided that the identification code is large enough to be detected through image processing.

The identification code is a two-dimensional code. Examples of the two-dimensional code include a quick response (QR) code or DataMatrix. Note that the identification code is not limited to a two-dimensional code, and may be, for example, a one-dimensional code, such as a bar code, or may be a three-dimensional code.

In learning the identification information, the control device 23 moves the stacker crane 4 to the position corresponding to the crane position information for the placement part 5 to be learned. The detecting section 23d of the control device 23 then analyzes the image taken by the image taking section 25 to detect an identification code, and obtains the identification information represented in the identification code. The detecting section 23d of the control device 23 further obtains a relative position of the identification code in the image taken by the image taking section 25 and uses the relative position as an identification code position information.

The detecting section 23d of the control device 23 stores the identification information that serves as information for identifying the placement part 5, and stores the crane position information and the identification code position information in association with the identification information. Alternatively, the identification code position information may be information including the crane position information and the relative position of the identification code, and only such identification code position information may be stored in association with the identification information.

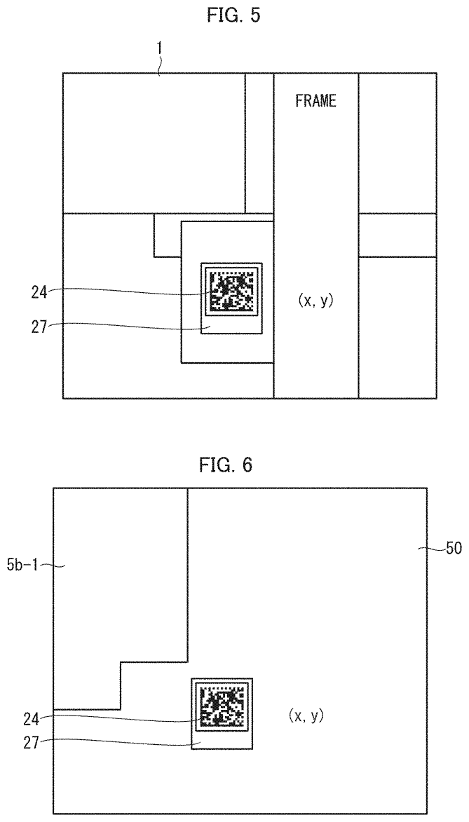

FIG. 5 is a diagram illustrating an example of an image containing an identification code affixed to a shelf 5a. As illustrated in FIG. 5, an identification code 24 marked on the plate member 27 is contained in the image taken by the image taking section 25. The detecting section 23d of the control device 23 detects an identification code from the image taken by the image taking section 25 and calculates a relative position (x,y) of the identification code 24. The center point of the identification code 24 may be used as the relative position (x,y), or any of the four corners of the identification code 24 may be used as the relative position (x,y).

FIG. 6 is a diagram illustrating an example of an image containing an identification code affixed to the device port 5b. As illustrated in FIG. 6, the identification code 24 marked on the plate member 27 is contained in the image taken by the image taking section 25. Note that the identification code 24 is affixed not only to the vicinity of the receipt part 5b-1 of the processing device 50 but also to the vicinity of the issue part 5b-2.

Procedure of Process Performed in Learning Identification Code Position Information

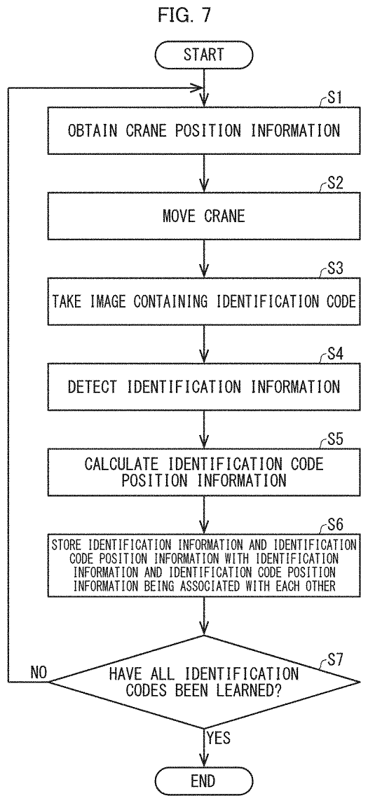

FIG. 7 is an explanatory flowchart of the procedure of a process to be performed in learning the placement part 5 of the automated warehouse system in accordance with an embodiment of the present invention. The control device 23 first obtains the crane position information corresponding to a placement part 5 to be learned (S1), and moves the stacker crane 4 to the placement part 5 to be learned in accordance with the crane position information (S2). The crane position information is set so as to be a middle position between the target stop position for unloading the object to be transported 1 and putting the same in the placement part 5 and the target stop position for scooping the object to be transported 1 and loading the same on the fork 12.

Next, the detecting section 23d of the control device 23 takes an image that contains the identification code via the image taking section 25 (S3), and analyzes the taken image to detect the identification code, and obtains identification information represented in the identification code (S4). The detecting section 23d of the control device 23 then calculates identification code position information indicating the position of the identification code within the image (S5).

Subsequently, the detecting section 23d of the control device 23 stores the identification information obtained from the identification code, the crane position information, and the identification code position information with the identification information, the crane position information, and the identification code position information being associated with each other (S6). Lastly, the control device 23 determines whether the placement parts 5 corresponding to all of the identification codes have been learned (S7).

If there is any placement part 5 that has not been learned (S7, No), then the control device 23 returns the process to step S1 and repeats step S1 and the subsequent steps. If the placement parts 5 corresponding to all of the identification codes have been learned (S7, Yes), then the control device 23 ends the process.

Procedure of Process Performed when Automated Warehouse System 100 is in Operation

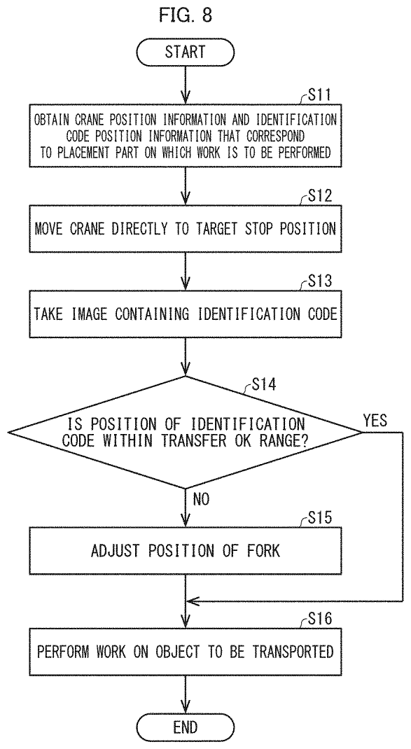

FIG. 8 is an explanatory flowchart of the procedure of a process performed when the automated warehouse system in accordance with an embodiment of the present invention is in operation. First, the control device 23 obtains crane position information and identification code position information that correspond to a placement part 5 on which work is to be performed (S11). The placement part 5 and the identification information are in one-to-one correspondence. This enables the control device 23 to obtain crane position information and identification code position information that correspond to a placement part 5 on which work is to be performed, by searching for the identification information.

The control device 23 then moves the stacker crane 4 directly to the target stop position in accordance with the crane position information (S12). The crane position information is set so as to be a middle position between the target stop position for unloading the object to be transported 1 and putting the same in the placement part 5 and the target stop position for scooping the object to be transported 1 and loading the same on the fork 12.

As an example, in a case of scooping the object to be transported 1 and removing the same from the placement part 5 by using the fork 12, the control device 23 moves the stacker crane 4 to a target stop position for scooping that is lower than the crane position information by a preset distance (e.g. 10 cm).

As another example, in a case of unloading the object to be transported 1 and putting the same in the placement part 5 by using the fork 12, the control device 23 moves the stacker crane 4 to a target stop position for unloading that is upper than the crane position information by a preset distance (e.g. 10 cm).

Next, the detecting section 23d of the control device 23 takes an image that contains the identification code via the image taking section 25 (S13). In taking the image, the control device 23 may analyze the taken image to detect the identification code, obtain identification information represented in the identification code, and determines whether the identification information agrees with registered identification information, in order to confirm that the placement part 5 is a correct one.

Subsequently, the control device 23 refers to the image taken by the image taking section 25 to determine whether the position of the identification code 24 having been taken is within a transfer OK range (S14).

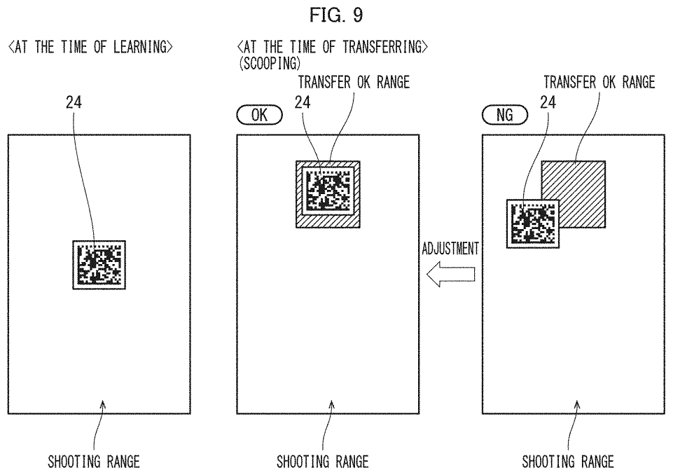

FIG. 9 is an explanatory diagram of a transfer OK range that is set within the shooting range of the image taking section 25. Assume that, when the identification code position information is learned, the position of the identification code 24 is approximately at the center of the shooting range, as illustrated in the left diagram of FIG. 9.

For example, in a case where the control device 23 moves the stacker crane 4 to the target stop position for scooping, the transfer OK range is set so as to be within the shooting range and be upper, by a preset distance (e.g. 10 cm), than the position of the identification code 24 at the time of learning, as illustrated in the right diagram of FIG. 9. The transfer OK range is set so as to be larger than the identification code 24. Illustrated in the right diagram of FIG. 9 is a case where the position of the identification code 24 having been taken is not within the transfer OK range.

If the position of the identification code 24 having been taken is not within the transfer OK range (S14, No), then the position of the fork 12 is adjusted (S15). The control device 23 adjusts the position of the fork 12 such that the position of the identification code 24 is within the transfer OK range, as illustrated in the middle diagram of FIG. 9. In this adjustment, the control device 23 adjusts the position of the fork 12 provided in the stacker crane 4 such that the position of the identification code 24 having been detected is within the transfer OK range, while referring to the image having been taken by the image taking section 25.

In a case where the control device 23 moves the stacker crane 4 to the target stop position for unloading, the transfer OK range is set so as to be within the shooting range and be lower, by a preset distance (e.g. 10 cm), than the position of the identification code 24 at the time of learning. The control device 23 then adjusts the position of the fork 12 such that the position of the identification code 24 is within the transfer OK range.

If the position of the identification code having been taken is within the transfer OK range (S14, Yes), then the process proceeds to step S16.

Lastly, the control device 23 performs work on the object to be transported 1 (S16) and then ends the process.

Effect of Automated Warehouse System 100

As described above, in the automated warehouse system 100 in accordance with the present embodiment, the detecting section 23d of the control device 23 detects an identification code from an image taken by the image taking section 25. When the identification code is contained in the image taken by the image taking section 25, it is possible for the detecting section 23d of the control device 23 to detect the identification code. This eliminates the need to manually adjust the position of the identification code at the time of startup of the automated warehouse system. It is therefore possible to ensure the safety of a worker and successfully shorten the working hours of the worker.

The identification code can have represented therein the identification information. This makes it easy to associate the placement part 5 with the identification information.

The identification code has represented therein identification information that is a unique, arbitrary value, and the placement part 5 and the identification information are in one-to-one correspondence. This enables the control device 23 to obtain crane position information and identification code position information that correspond to a placement part 5 on which work is to be performed, by searching for the identification information.

The control device 23 stores the identification information and the identification code position information with the identification information and the identification code position information being associated with each other. This makes it possible to easily obtain identification code position information corresponding to a shelf 5a on which work is to be performed, by searching for the identification information.

The control device 23 stores the identification information and the identification code position information with the identification information and the identification code position information being associated with each other. This makes it possible to easily obtain identification code position information corresponding to a device port 5b on which work is to be performed, by searching for the identification information. Further, affixing an identification code to each of the receipt part 5b-1 and the issue part 5b-2 of the device port 5b makes it easy to control the storage of the object to be transported 1 in the processing device 50 and control the retrieval of the object to be transported 1 from the processing device 50.

The device port 5b varies in shape, etc. depending on the maker. Affixing the identification code to an appropriate position is therefore difficult. However, when the identification code is contained in an image taken by the image taking section 25, it is possible for the detecting section 23d of the control device 23 to detect the identification code, as described above. The above configuration is therefore applicable to the device port 5b.

The detecting section 23d of the control device 23 calculates identification code position information from a relative position of the identification code in the image taken by the image taking section 25, and stores the identification code position information in association with the identification information of the placement part 5. This makes it possible to easily perform the position adjustment, etc. of the fork 12 in accordance with the identification code position information when the automated warehouse system 100 is in operation.

Software Implementation Example

Control blocks of the automated warehouse system 100 (particularly, the control device 23) can be implemented by a logic circuit (hardware) provided in an integrated circuit (IC chip) or the like or can be alternatively implemented by software.

In the latter case, the control device 23 includes a computer that executes instructions of a program that is software realizing the foregoing functions. The computer, for example, includes at least one processor and at least one computer-readable storage medium storing the program. An object of the present invention can be achieved by the processor of the computer reading and executing the program stored in the storage medium. Examples of the processor encompass a central processing unit (CPU). Examples of the storage medium encompass a “non-transitory tangible medium” such as a read only memory (ROM), a tape, a disk, a card, a semiconductor memory, and a programmable logic circuit. The computer may further include a random access memory (RAM) or the like in which the program is loaded. Further, the program may be supplied to or made available to the computer via any transmission medium (such as a communication network and a broadcast wave) which allows the program to be transmitted. Note that an aspect of the present invention can also be achieved in the form of a computer data signal in which the program is embodied via electronic transmission and which is embedded in a carrier wave.

Aspects of the present invention can also be expressed as follows:

An automated warehouse system in accordance with an aspect of the present invention includes: an automated warehouse in which an object to be transported is transferred by using a crane; and a control device for controlling the crane, the automated warehouse system including a plurality of placement parts in which to place the object to be transported and which are fixed to the automated warehouse, each of the plurality of placement parts having marked thereon an identification code representing identification information for identifying that placement part, the crane including a carriage equipped with an image taking section for taking an image, the control device being configured to: detect the identification information represented by the identification code from an image that is taken by the image taking section and that contains the identification code of a placement part of the plurality of placement parts; and store the identification information having been detected and crane position information concerning a position where the crane is located when the image is taken, with the identification information having been detected and the crane position information being associated with each other.

With this configuration, it is possible for the control device to detect the identification code, provided that the identification code is contained in the image taken by the image taking section. This eliminates the need to manually adjust the position of the identification code. It is therefore possible to ensure the safety of a worker and successfully shorten the working hours of the worker.

In the automated warehouse system, the control device is configured to: calculate, from the image containing the identification code and the crane position information, identification code position information concerning a position of the identification code; and store the identification information and the identification code position information having been calculated, with the identification information and the identification code position information having been calculated being associated with each other.

With this configuration, since the control device stores the identification information and the identification code position information with the identification information and the identification code position information being associated with each other, it is possible to easily obtain identification code position information corresponding to a placement part on which work is to be performed, by searching for the identification information.

In the automated warehouse system, the control device is configured to calculate the identification code position information from the crane position information and a relative position of the identification code in the image.

With this configuration, when the automated warehouse system is in operation, it is possible for the control device to easily adjust the position of the fork, etc. in accordance with the identification code position information.

In the automated warehouse system, the plurality of placement parts include a device port including a receipt part or an issue part of a processing device configured to perform a process on the object to be transported, and the control device is configured to store the identification information corresponding to the device port and the identification code position information with the identification information corresponding to the device port and the identification code position information being associated with each other.

With this configuration, since the control device stores the identification information and the identification code position information with the identification information and the identification code position information being associated with each other, it is possible to easily obtain identification code position information corresponding to a device port on which work is to be performed, by searching for the identification information.

In the automated warehouse system, the plurality of placement parts include a shelf, and the control device is configured to store the identification information corresponding to the shelf and the identification code position information with the identification information corresponding to the shelf and the identification code position information being associated with each other.

With this configuration, since the control device stores the identification information and the identification code position information with the identification information and the identification code position information being associated with each other, it is possible to easily obtain identification code position information corresponding to a shelf on which work is to be performed, by searching for the identification information.

In the automated warehouse system, the carriage of the crane is provided with a fork for transferring the object to be transported, and the control device is configured to adjust a position of the fork relative to the placement part in accordance with the identification code position information, in a case of loading, on the fork, the object to be transported.

With this configuration, it is possible to easily perform work of loading, on the fork, an object to be transported.

In the automated warehouse system, the carriage of the crane is provided with a fork for transferring the object to be transported, and the control device is configured to adjust a position of the fork relative to the placement part in accordance with the identification code position information, in a case of unloading, from the fork, the object to be transported.

With this configuration, it is possible to easily perform work of unloading, from the fork, the object to be transported.

In the automated warehouse system, the identification code is a two-dimensional code.

In the automated warehouse system, the identification code is marked on a plate member or a sticker.

An automated warehouse control method in accordance with an aspect of the present invention is a method for controlling an automated warehouse in which an object to be transported is transferred by using a crane, the automated warehouse including a plurality of placement parts in which to place the object to be transported and which are fixed to the automated warehouse, each of the plurality of placement parts having marked thereon an identification code representing identification information for identifying that placement part, the crane including a carriage equipped with an image taking section for taking an image, the method including: detecting the identification information represented by the identification code from an image that is taken by the image taking section and that contains the identification code of a placement part of the plurality of placement parts; and storing the identification information having been detected and crane position information concerning a position where the crane is located when the image is taken, with the identification information having been detected and the crane position information being associated with each other.

With this configuration, it is possible for the control device to detect the identification code, provided that the identification code is contained in the image taken by the image taking section. This eliminates the need to manually adjust the position of the identification code. It is therefore possible to ensure the safety of a worker and successfully shorten the working hours of the worker.

Supplementary Note

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: Object to be transported
2: Article storage rack
3: Moving space
4: Stacker crane
5: Placement part
5a: Shelf
5b: Device port
11: Carriage
12: Fork
18: Raising and lowering electric motor
19: Raising and lowering encoder
21: Traveling electric motor
22: Traveling encoder
23: Control device
24: Identification code
25: Image taking section
27: Plate member
100: Automated warehouse system

1. An automated warehouse system comprising:
an automated warehouse in which an object to be transported is transferred by using a crane; and
a control device for controlling the crane,
the automated warehouse system including a plurality of placement parts in which to place the object to be transported and which are fixed to the automated warehouse,
each of the plurality of placement parts having marked thereon an identification code representing identification information for identifying that placement part,
the crane including a carriage equipped with an image taking section for taking an image,
the control device being configured to:
detect the identification information represented by the identification code from an image that is taken by the image taking section and that contains the identification code of a placement part of the plurality of placement parts; and
store the identification information having been detected and crane position information concerning a position where the crane is located when the image is taken, with the identification information having been detected and the crane position information being associated with each other.

2. The automated warehouse system according to claim 1, wherein
the control device is configured to:
calculate, from the image containing the identification code and the crane position information, identification code position information concerning a position of the identification code; and
store the identification information and the identification code position information having been calculated, with the identification information and the identification code position information having been calculated being associated with each other.

3. The automated warehouse system according to claim 2, wherein
the control device is configured to
calculate the identification code position information from the crane position information and a relative position of the identification code in the image.

4. The automated warehouse system according to claim 2, wherein:
the placement part is a device port including a receipt part or an issue part of a processing device configured to perform a process on the object to be transported; and
the control device is configured to
store the identification information corresponding to the device port and the identification code position information with the identification information corresponding to the device port and the identification code position information being associated with each other.

5. The automated warehouse system according to claim 2, wherein:
the placement part is a shelf; and
the control device is configured to
store the identification information corresponding to the shelf and the identification code position information with the identification information corresponding to the shelf and the identification code position information being associated with each other.

6. The automated warehouse system according to claim 2, wherein:
the carriage of the crane is provided with a fork for transferring the object to be transported; and
the control device is configured to
adjust a position of the fork relative to the placement part in accordance with the identification code position information, in a case of loading, on the fork, the object to be transported.

7. The automated warehouse system according to claim 2, wherein:
the carriage of the crane is provided with a fork for transferring the object to be transported; and
the control device is configured to
adjust a position of the fork relative to the placement part in accordance with the identification code position information, in a case of unloading, from the fork, the object to be transported.

8. The automated warehouse system according to claim 1, wherein
the identification code is a two-dimensional code.

9. The automated warehouse system according to claim 1, wherein
the identification code is marked on a plate member or a sticker.

10. A method for controlling an automated warehouse in which an object to be transported is transferred by using a crane,
the automated warehouse including a plurality of placement parts in which to place the object to be transported and which are fixed to the automated warehouse,
each of the plurality of placement parts having marked thereon an identification code representing identification information for identifying that placement part,
the crane including a carriage equipped with an image taking section for taking an image,
the method comprising:
detecting the identification information represented by the identification code from an image that is taken by the image taking section and that contains the identification code of a placement part of the plurality of placement parts; and
storing the identification information having been detected and crane position information concerning a position where the crane is located when the image is taken, with the identification information having been detected and the crane position information being associated with each other.
